(19) United States
(12) Patent Application Publication
(10) Pub. No.: US 2022/0394980 A1
(43) Pub. Date: Dec. 15, 2022

(54) BIODEGRADABLE SHEET WITH ANTIVIRAL PROPERTIES, MANUFACTURING METHOD THEREOF, AND USE THEREOF

(71) Applicants: BGF EcoBio, Seoul (KR); K B F CO., LTD, Hwaseong-si (KR)

(72) Inventors: Jung Hyuk HONG, Seoul (KR); Jongkoo JEONG, Seongnam-si (KR); Jin Woo KIM, Bucheon-si (KR); Dong Wook LEE, Seoul (KR); Sung Ho WOO, Incheon (KR)

(21) Appl. No.: 17/393,745

(22) Filed: Aug. 4, 2021

Related U.S. Application Data
(63) Continuation of application No. PCT/KR2021/008131, filed on Jun. 29, 2021.

(30) Foreign Application Priority Data
Jun. 10, 2021 (KR) 10-2021-0075589

(51) Int. Cl. A01N 59/16; A01N 59/20; A01N 25/10; B29B 7/90; B29C 44/20; B29C 44/50; B32B 27/06; B32B 27/20; B32B 27/36; B32B 37/18

(52) U.S. Cl. CPC A01N 59/16; A01N 59/20; A01N 25/10; B29B 7/90; B29C 44/20; B29C 44/505; B32B 27/065; B32B 27/20; B32B 27/36; B32B 37/182; B29K 2067/046

(57) ABSTRACT

Provided are a biodegradable sheet with antiviral properties, a manufacturing method thereof, and the use thereof. The biodegradable sheet comprises: a biodegradable polymer resin consisting of a polylactic acid-based polymer; or a composite degradable polymer resin comprising of a biodegradable resin and a petrochemical resin; and particles of an inorganic antiviral agent or aggregated composite particles of at least two inorganic antiviral agents incorporated into the biodegradable sheet so that the inorganic antiviral agent can be dispersed with a particle size of 100 to 900 nm.

### TECHNICAL FIELD

The present invention relates to a biodegradable sheet with antiviral properties, a manufacturing method thereof, and the use thereof, and more particularly to a biodegradable sheet, a manufacturing method thereof, and the use thereof, where particles of an inorganic antiviral agent or aggregated composite particles of at least two inorganic antiviral agents are incorporated into a biodegradable sheet comprised of a biodegradable polymer resin consisting of a polylactic acid (PLA)-based polymer; or a composite degradable polymer resin comprising of a biodegradable resin and a petrochemical resin so that they can be dispersed with a particle size of 100 to 900 nm in the biodegradable sheet, allowing the biodegradable sheet not only to prevent skin penetration of the particles by the particle size control of the inorganic antiviral agent, but to exercise good antiviral properties upon in contact with external viruses.

### BACKGROUND ART

Microorganisms or microbes are tiny living things that are found all around us. Some are beneficial to human life, others like pathogenic microbes, including some bacteria, fungi and viruses, can do a serious harm to human body, causing illness and making a foul odor.

With an epidemic outbreak of diseases such as SARS and swine flu since the 2000s, interest in harmful microorganisms has increased and continuous research has been conducted to prevent bacterial and virus infections.

Particularly in the situation that the spread of the new coronavirus (COVID-19) is not slowing down, the development of personal protective equipment (PPE) and household items with antiviral properties along with daily prevention against epidemics is required due to the nature of the viruses that are transmitted through contact.

The possibility of the existence of viruses was already suggested at the end of the 19th century. But the existence of the virus was not confirmed until the 1930s, which was because of the fact that the viruses are too small. In general, the average human cell size is 20-100 μm, and bacteria are smaller than this, at the level of 1-10 μm. Although it varies from person to person, the minimum size visually distinguishable is about 0.1 mm, so bacteria are impossible to see with the naked eye. Yet, the presence of bacteria can be sufficiently confirmed by using an optical microscope.

Viruses are, however, much smaller than bacteria, with an average size of about 10-300 nm. Most viruses cannot be seen with an optical microscope of which the maximum magnification power was no more than 1000×. It was therefore possible to detect the presence of viruses only after the development of electron microscopes with much higher magnification (1,000,000× magnification at the most).

A virus is an organism that has the characteristics of living and non-living things at once and basically is of a simple structure containing nucleic acid (either DNA or RNA) that is a genetic material enclosed by a protein coat.

Unlike bacteria, viruses do not have their own metabolism and thus cannot carry out their life-sustaining functions alone. Once in a host cell, they parasitize the host cell during the cell's life activity and reproduce the genetic material and the protein coat to multiply the population.

When it comes into contact with a host cell, a virus that exists in the form of protein crystals attaches to the cell membrane of the host cell and penetrates into the host cell. In the host cell, it uses the host cell's genetic material replication function and protein production function to produce more genetic material and protein coat of its own and then reassemble them, multiplying virus cells that resemble it.

Viruses do not invade all types of cells into the host, and the type of host cell differs from virus to virus.

Viruses are generally classified by the host cells they infect: animal viruses, plant viruses, and bacterial viruses. Every virus contains one type of nucleic acid, either DNA or RNA, so it can also be classified into DNA virus or RNA virus.

With a surge in outbreaks of virus infection, such as SARS, avian flu, and collective food poisoning, and the spread of coronavirus (COVID-19) in recent days, there is an urgent demand in the market for antiviral personal items and disposable products.

Patent Document 1 discloses an invention related to a nano-silver antibacterial plastic pellet. According to the disclosure of the cited invention, colloidal nano-silver is added to a pellet-form plastic raw material (e.g., PE, PP, PVC, ABS, AS, PS, etc.) at a certain ratio to obtain a master batch, which is molded into pellets. The nano-coating layer formed on the surface of the master batch imparts an antibacterial effect to the surface and material of plastic products of which the raw material is mixed with the master batch at a certain ratio to reform products (e.g., a plastic film, sheet, or molded article).

Yet, conventional inventions provide efficacies without distinction between antibacterial and antiviral. Particularly, the above invention discloses a method of preparing colloidal nano-silver in the form of pellets and conducting a molding with the nano-silver pellets to form a silver coating applied to the surface of the pellets. However, the colloidal particle size is in the range of 20-50 nm.

On the other hand, Non-Patent Document 1 reports the adverse effects of silver ions or silver nanoparticles on the environment and the human health, suggesting that the silver nanoparticles are beneficial as an antibacterial substance but cytotoxic when their particle size is 5-50 nm.

Based on this report, stability issue has arisen from the fact that silver nanoparticles with the above nanoparticle size, when applied to the human body, can reach organs through the intercellular space (75 nm) of the skin. For that reason, in Europe (Scientific Committee on Emerging and Newly Identified Health Risks), substances with a particle size less than 100 nm are defined as nano-materials and restricted in use. In consideration of the potential harmful effects on the human body, it is regulated to use particles at least 50% of which are larger than 100 nm.

Nevertheless, Non-Patent Document 2 suggests that the coronavirus survives on various surfaces for several tens of hours to seven days and that a traditional disinfection-associated cleansing method is no more than temporary measures because it may return the state before the cleansing in 2.5 hours. So, it introduces the need for research on the active surfaces for the sake of coping with the adhesion, colonization and subsequent proliferation of the viruses and suggests surfaces that pose resistance to virus infection with a natural, artificial, or biomimetic coating. As such an approach, despite the debates over the cytotoxicity and biocompatibility of nanoparticles to human cells, the use of silver-, gold-, copper-, zinc oxide-, titanium dioxide-, or carbon-based nanotubes or nanoparticles including bio-nanoparticles like chitosan is expected to have an effect to significantly increase the contact area with microbes, including viruses of which the size is 1-10 nm.

Further, Non-Patent Document 3 suggests that targeting viruses at an initial stage can be a promising approach to securing extracellular inhibition of viruses. It is disclosed that the surface modified with metal nanoparticles is capable of serving as a most potent inhibitor against colonization and furthermore proliferation of viruses. Specifically, it is reported that the interaction between viruses and metal nanoparticles can provide early protection against virus infection into host cells by interrupting viral target proteins through virus introduction, oxidation of capsid proteins, mimic of cell surface, or mechanical destruction of viruses.

In addition, Non-Patent Document 4 states that among various nanoparticles, silver nanoparticles are known to be substantially effective against bacteria, viruses and even eukaryotes and that researches have been conducted on the silver nanoparticles provided in the form of pure particles or encapsulated with mercaptoethanesulfonate (MES), poly N-vinyl-2-pyrrolidone (PVP), polysaccharides, etc. against a variety of viruses, such as human immunodeficiency virus (HIV), respiratory syncytial virus, and hepatitis B virus.

Accordingly, the inventors of the present invention have carefully addressed the problems and needs with the prior art. In an effort to provide an antiviral plastic sheet, it has been confirmed that when particles of an inorganic antiviral agent or aggregated composite particles of at least two inorganic antiviral agents are incorporated with a particle size of 100 to 900 nm into a biodegradable sheet comprised of a biodegradable polymer resin consisting of a polylactic acid-based polymer; or a composite degradable polymer resin comprising a biodegradable resin and a petrochemical resin, the biodegradable sheet is enabled not only to prevent skin penetration of particles by the particle size control of the inorganic antiviral agent, but to exercise an antiviral performance upon in contact with external viruses by inactivation of the viruses prior to virus infection into the human body or inhibition of RNA replication even in the case of virus infection, thereby completing the present invention.
(Patent Document 1) Korean Patent No. 0854730 (published on Aug. 27, 2008).
(Non-Patent Document 1) “Silver or silver nanoparticles: a hazardous threat to the environment and human health”, J. Appl. Biomed., 2008, 6, 117-129.
(Non-Patent Document 2) “A critical evaluation of current protocols for self-sterilizing surfaces designed to reduce viral nosocomial infections”, Am. J. Infect. Control, 2020, 48, P1255-1260.
(Non-Patent Document 3) “Hard Nanomaterials in Time of Viral Pandemics”, ACS Nano, 2020, 14(8), 9364-9388.
(Non-Patent Document 4) “Metal nanoparticles: The protective nanoshield against virus infection”, Crit Rev Microbiol, 2016, 42(1), 46-56.

### SUMMARY OF THE DISCLOSURE

It is an object of the present invention to provide a biodegradable sheet with antiviral properties.

It is another object of the present invention to provide a method for manufacturing a biodegradable sheet with antiviral properties.

It is further another object of the present invention to provide a molded product applicable to a variety of uses with a biodegradable sheet having antiviral properties.

To achieve the objects of the present invention, there is provided a biodegradable sheet with antiviral properties that includes: a biodegradable polymer resin consisting of a polylactic acid-based polymer; or a composite degradable polymer resin comprising of a biodegradable resin and a petrochemical resin; and particles of an inorganic antiviral agent or aggregated composite particles of at least two inorganic antiviral agents incorporated into the biodegradable sheet so that the inorganic antiviral agent can be dispersed with a particle size of 100 to 900 nm.

In the biodegradable sheet with antiviral properties according to the present invention, the inorganic antiviral agent may be any one or a combination of at least two selected from the group consisting of a silver nanocomposite, a silver ion-containing nanocomposite, copper(I) compound nanoparticles, zinc oxide nanoparticles, and ferrite nanoparticles.

Further, the silver nanocomposite or the silver ion-containing nanocomposite may be preferably silver nanoparticles or silver ion-containing nanoparticles adsorbed on or bound to any one selected from the group consisting of a mineral, talc, a cellulose derivative, paraffin, and wax. Here, the mineral may include silica (SiO₂), alumina, zeolite, sericite, mordenite, cristobalite, and bentonite.

The ferrite nanoparticles may be at least one or more selected from the group consisting of alpha-ferrite (α-Fe₂O₃), zinc ferrite (ZnFe₂O₄), manganese ferrite (MnFe₂O₄), nickel ferrite (NiFe₂O₄), and ferric hydroxide (aα-FeOOH).

The biodegradable sheet with antiviral properties according to the present invention may contain 0.1 to 60 parts by weight of the inorganic antiviral agent with respect to 100 parts by weight of the biodegradable polymer resin or the multi-degradable polymer resin.

In the biodegradable sheet of the present invention, a preferred example of the raw material resin for the biodegradable polymer resin consisting of a polylactic acid (PLA)-based polymer or the multi-degradable polymer resin consisting of a biodegradable resin and a petrochemical resin may be any one or a combination of at least two selected from the group consisting of polylactic acid (PLA), polyhydroxyalkanoate (PHA), polybutylene adipate-co-terephthalate (PBAT), polybutylene succinate-co-adipate (PBSA), polybutylene succinate adipate-co-terephthalate (PBSAT), polybutylene succinate (PBS), polyvinyl alcohol (PVA), poly glycolic acid (PGA), poly lactic-co-glycolic acid (PLGA), polycaprolactone (PCL), modified starch resin, and thermoplastic starch (TPS).

The biodegradable sheet of the present invention may be comprised of any one or at least one plant material selected from the group consisting of pulp, bagasse and flax fiber.

In a preferred embodiment, the present invention provides a biodegradable sheet with antiviral properties in which a non-foam sheet containing an inorganic antiviral agent in a bio-degradable polymer resin consisting of a polylactic acid (PLA)-based polymer or a petrochemical resin is laminated on at least one side of an extruded foam sheet prepared by extrusion foaming using a mixture containing 0.05 to 4 parts by weight of a chain extender, 0.01 to 4 parts by weight of any one nucleating agent selected from the group consisting of talc, silica, and calcium stearate, and 1 to 30 parts by weight of a physical foaming agent with respect to 100 parts by weight of a biodegradable polymer resin.

In the embodiment, the present invention provides a biodegradable sheet with antiviral properties in which a non-foam sheet containing an inorganic antiviral agent in a bio-degradable polymer resin consisting of a polylactic acid-based polymer or a petrochemical resin is laminated on at least one side of an extruded foam sheet into which an organic antiviral agent is further incorporated so that particles of an inorganic antiviral agent or aggregated composite particles of at least two inorganic antiviral agents can be dispersed with a particle size of 100 to 900 nm.

In the embodiment, the non-foam sheet may contain 0.1 to parts by weight of the inorganic antiviral agent with respect to 100 parts by weight of the biodegradable polymer resin consisting of a polylactic acid-based polymer or the petrochemical resin. Preferably, the thickness of the non-foam sheet may be 50 to 500 μm.

The biodegradable sheet with antiviral properties according to the present invention may exert an antiviral performance against at least one selected from the group consisting of feline coronavirus (fCoV), influenza A virus (FluA), avian influenza (AI) virus, and swine virus.

Furthermore, the present invention provides a molded product using the biodegradable sheet with antiviral properties applied to any one selected from the group consisting of food trays, food containers, medicinal containers, industrial containers, parts of personal protective equipment (PPE) or air purifiers, industrial packaging boxes, and packaging materials.

The present invention can provide a biodegradable sheet with good antiviral properties, where particles of an inorganic antiviral agent or aggregated composite particles of at least two inorganic antiviral agents are incorporated into the biodegradable sheet so that they can be dispersed with a particle size of 100 to 900 nm, which enables the biodegradable sheet not only to prevent skin penetration of particles by the particle size control of the inorganic antiviral agent, but also to have the inorganic antiviral agent exercise an antiviral performance upon in contact with external viruses by inactivation of the viruses prior to virus infection into the human body or inhibition of RNA replication even in the case of virus infection.

Even when viruses, particularly RNA viruses have infected the human body, the nanoparticles of the inorganic antiviral agent are adsorbed on the RNA to interfere with RNA replication, thereby exercising an antiviral performance.

In addition, the biodegradable sheet with antiviral properties according to the present invention uses a resin selected from a biodegradable polymer resin consisting of a polylactic acid-based polymer; or a multi-degradable polymer resin consisting of a biodegradable resin and a petrochemical resin, or at least one plant material selected from the group consisting of pulp, bagasse and flax fiber. According to the use purpose of the final product, a variety of molded products can be provided to meet the needs of the market for personal items or disposable products against different viruses causing severe acute respiratory syndrome (SARS), avian flu, mass food poisoning, coronavirus (COVID-19) infection, etc.

### BRIEF DESCRIPTION OF THE DRAWINGS

FIG. 1 is a diagram showing the cross-section of a biodegradable non-foam sheet with antiviral properties according to a first embodiment of the present invention.

FIG. 2 is a diagram showing the cross-section of a biodegradable extruded foam sheet with antiviral properties according to another example of the first embodiment of the present invention.

FIG. 3 is a diagram showing the cross-section of a biodegradable sheet with antiviral properties according to a second embodiment of the present invention.

FIG. 4 is a diagram showing the cross-section of a biodegradable sheet with antiviral properties according to a third embodiment of the present invention.

FIG. 5 is a picture showing the cross-section of a ZnO-incorporated PLA(nZnO) biodegradable sheet prepared in Example 1 of the present invention.

FIG. 6 is a picture showing the cross-section of a ZnO/CuI-incorporated PLA(CuZn) biodegradable sheet prepared in Example 2 of the present invention.

FIG. 7 is a picture showing the cross-section of a silver nanocomposite-incorporated PLA(AgNP) biodegradable sheet prepared in Example 3 of the present invention.

FIG. 8 is a picture showing the cross-section of a CuI-incorporated PLA(CuI) biodegradable sheet prepared in Example 4 of the present invention.

FIG. 9 is a picture showing the cross-section of a ZnO/silver nanocomposite/CuI-incorporated PLA(nZnAgCu) biodegradable sheet prepared in Example 5 of the present invention.

### DETAILED DESCRIPTION OF THE DISCLOSURE

Hereinafter, the present invention will be described in detail.

The present invention provides a biodegradable sheet with antiviral properties that is applied to a polymer sheet having a very even fine surface relative to paper.

Specifically, in accordance with a first preferred embodiment of the present invention, there is provided a biodegradable sheet with antiviral properties, where particles of an inorganic antiviral agent or aggregated composite particles of at least two inorganic antiviral agents are incorporated into a biodegradable sheet comprised of a biodegradable polymer resin consisting of a polylactic acid-based polymer; or a composite degradable polymer resin comprising of a biodegradable resin and a petrochemical resin so that the inorganic antiviral agent can be dispersed with a particle size of 100 to 900 nm.

In the first embodiment of the present invention, the term “biodegradable sheet” refers to a single-layered, multi-layered, non-foam, or foam structure formed by T-die, blown and extrusion foaming using a raw material resin that includes a biodegradable polymer resin consisting of a polylactic acid-based polymer; or a multi-degradable polymer resin consisting of a biodegradable resin and a petrochemical resin. The structure with a thickness of 0.254 mm or greater is defined as a sheet, whereas the structure with a thickness less than 0.245 mm is defined as a film. But the structure in either case is generally referred to as “sheet”.

The biodegradable sheet of the present invention may also use any one or at least one plant material selected from the group consisting of pulp, bagasse and flax fiber as a raw material. The bagasse is a material prepared by drying a plant material, such as sugar cane residue and pineapple peel.

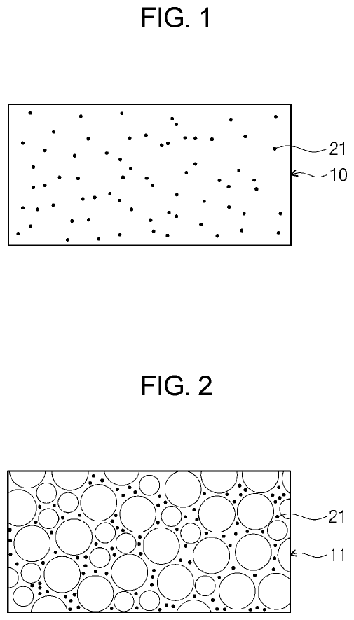

FIGS. 1 and 2 are diagrams showing the cross-section of a biodegradable sheet with antiviral properties according to a first embodiment of the present invention: FIG. 1 shows that inorganic antiviral agent 21 is incorporated into a biodegradable non-foam sheet 10; and FIG. 2 shows that inorganic antiviral agent 21 is incorporated into a biodegradable extruded foam sheet 11.

Hereinafter, a detailed description will be given as to the composition-specific characteristics of the biodegradable sheet with antiviral properties according to the present invention.
(1) Raw material resin of biodegradable sheet

Used as a raw material resin, the biodegradable polymer resin consisting of a polylactic acid-based polymer may be a crystalline polylactic acid alone or in combination with an amorphous polylactic acid. The mixing ratio of the crystalline polylactic acid to the amorphous polylactic acid can be adjusted in order to secure the impact resistance of the polylactic acid resin and the molding stability in the mold, and the heat resistance stability of the molded product as well.

Another raw material resin may be a polylactic acid-based polymeric composition acquired by optimization of a material for the multi-degradable polymer resin prepared by mixing a petrochemical resin and a biodegradable resin including the polylactic acid at a certain ratio within the range that meets the requirements for bio-based plastics in consideration of strength and productivity. Preferably, the composition is comprised of 60 to 99 wt. % of the biodegradable resin and 1 to 40 wt. % of the petrochemical resin. Here, the biodegradable resin may include poly L-lactic acid (hereinafter, referred to as “PLLA”) and poly D-lactic acid (hereinafter, referred to as “PDLA”), and further include another known biodegradable resin. The preferred biodegradable resin may include any one or a combination of at least two selected from the group consisting of polyhydroxyalkanoate (PHA), polybutylene adipate-co-terephthalate (PBAT), polybutylene succinate-co-adipate (PBSA), polybutylene succinate adipate-co-terephthalate (PBSAT), polybutylene succinate (PBS), polyvinyl alcohol (PVA), poly glycolic acid (PGA), poly lactic-co-glycolic acid (PLGA), polycaprolactone (PCL), modified starch resin, and thermoplastic starch (TPS).

The petrochemical resin is preferably any one thermoplastic resin or a combination of at least two thermoplastic resins selected from the group consisting of polystyrene, polyethylene, polypropylene, polyester, polycarbonate, acrylic resin, ethylene vinyl acetate resin, polyvinyl alcohol, or polyvinyl chloride. Yet, it is not specifically limited to the mentioned polymer resin and may include any other polymer resin. Here, the petrochemical resin is contained in an amount of 1 to 40 wt. %. When the content of the petrochemical resin is less than 1 wt. %, the content of the biodegradable polymer resin relatively increases to enhance degradability but insignificantly raise thermal resistance, consequently improving the effect of increasing composite properties expected by the addition of the petrochemical resin. When the content of the petrochemical resin exceeds 40 wt. %, there is a problem that it prevents low carbon dioxide footprint that is characteristic to PLA.

The composite degradable polymer resin composition, in relation to a single biodegradable resin, shortens the biodegradation period or, in some cases, improves fastness to extend the service life.
(2) Inorganic antiviral agent

In the biodegradable sheet with antiviral properties according to the present invention, the inorganic antiviral agent is any one or a combination of at least two selected from the group consisting of a silver nanocomposite, a silver ion-containing nanocomposite, copper(I) compound nanoparticles, zinc oxide nanoparticles, and ferrite nanoparticles.

Among the inorganic antiviral agents, silver nanoparticles have been studied in a sustainable manner because they are known to have antibacterial or antivirus activity. According to the results of a study claiming that the activity of the silver nanoparticles has a dependence on the particle size, the silver nanoparticles with a very small particle size of 5 to 50 nm can penetrate the skin and cause toxicity. In this regard, the harmful risk of the silver nanoparticles has emerged as a steady issue [Non-Patent Document 1].

For this reason, the present invention has the inorganic antiviral agent incorporated into the biodegradable sheet in such a manner that particles of an inorganic antiviral agent or aggregated composite particles of at least two inorganic antiviral agents can be dispersed with a particle size of 100 to 900 nm. This not only prevents skin penetration of the particles through particle size control of the inorganic antiviral agent, but also exercises good antiviral properties upon in contact with external viruses.

Alternatively, the present invention uses a composite in the form of a support having a three-dimensional frame structure with fine pores as an example of supporting an antibacterial metal component. A preferred example is a composite that includes silver nanoparticles or silver ion-containing nanoparticles adsorbed on or bound to any one selected from the group consisting of a mineral, talc, a cellulose derivative, paraffin and wax, where the mineral may include silica (SiO₂), alumina, zeolite, sericite, mordenite, cristobalite and bentonite. The present invention may further include a known support as long as it supports the silver nanoparticles or silver ion-containing nanoparticles.

If the particle size of the composite in the form of a support is 100 to 900 nm, the silver nanoparticles or silver ion-containing nanoparticles on the support may have a particle size of 1 to 100 nm.

Although it is described in an embodiment of the present invention that the silver ion-containing nanocomposite uses silica particles bound to silver and zinc ions, the present invention is not limited to this described embodiment.

Another inorganic antiviral agent available in the present invention to exercise antiviral properties is a copper compound, such as CuO, preferably a copper(I) compound, i.e., CuI, CuCl, Cu₂S or Cu₂O.

Although it is described in an embodiment of the present invention that the copper(I) compound is CuI, the present invention is not specifically limited to this described embodiment and the copper(I) compound may include any ionic compound in which a copper(I) cation is combined with an anion by ionic bonding.

Further another inorganic antiviral agent available in the present invention is zinc oxide nanoparticles, which are metal oxide nanoparticles that have strong antibacterial power and high stability and pose no harm to human body.

In an embodiment of the present invention, a composite of the zinc oxide nanoparticles and ferrite nanoparticles is more preferable to exercise an antiviral performance. In this regard, the ferrite nanoparticles are at least one or more selected from the group consisting of alpha-ferrite (α-Fe₂O₃), zinc ferrite (ZnFe₂O₄), manganese ferrite (MnFe₂O₄), nickel ferrite (NiFe₂O₄), and ferric hydroxide (aα-FeOOH).

Specifically, in an inorganic antiviral agent that is a composite of zinc oxide (ZnO) nanoparticles and ferrite nanoparticles as used in an embodiment of the present invention, the ferrite nanoparticles are a combination of alpha-ferrite (α-Fe₂O₃), zinc ferrite (ZnFe₂O₄) and manganese ferrite (MnFe₂O₄). Yet, at least two-component composite particles may come in different combinations of components, provided that they meet the requirements for the particle size.

In the biodegradable sheet with antiviral properties according to the present invention, the inorganic antiviral agent is preferably contained in an amount of 0.1 to 60 parts by weight, and more preferably 1 to 30 parts by weight, with respect to 100 parts by weight of the biodegradable polymer resin consisting of a polylactic acid-based polymer or the multi-degradable polymer resin consisting of a biodegradable resin and a petrochemical resin. In this regard, the content of the inorganic antiviral agent less than 0.1 part by weight is too insignificant to exert an antiviral performance. The content of the inorganic antiviral agent greater than 60 parts by weight is also undesirable as it may deteriorate economic feasibility and significantly reduce polymeric properties and processability due to using an excess of the inorganic antiviral agent.

In accordance with a second preferred embodiment of the present invention, there is provided a biodegradable sheet with antiviral properties in which a non-foam sheet containing an inorganic antiviral agent in a bio-degradable polymer resin consisting of a polylactic acid-based polymer or a petrochemical resin is laminated on at least one side of an extruded foam sheet prepared by extrusion foaming using a mixture containing 0.05 to 4 parts by weight of a chain extender, 0.01 to 4 parts by weight of any one nucleating agent selected from the group consisting of talc, silica and calcium stearate, and 1 to 30 parts by weight of a physical foaming agent with respect to 100 parts by weight of the biodegradable polymer resin consisting of a polylactic acid-based polymer.

In accordance with a third preferred embodiment of the present invention, there is provided a biodegradable sheet with antiviral properties in which a non-foam sheet containing an inorganic antiviral agent in a bio-degradable polymer resin consisting of a polylactic acid-based polymer or a petrochemical resin is laminated on at least one side of an extruded foam sheet into which an inorganic antiviral agent is incorporated so that particles of an inorganic antiviral agent or aggregated composite particles of at least two inorganic antiviral agents can be dispersed with a particle size of 100 to 900 nm.

In the embodiment, the word “laminate” means forming a multi-layered structure by means, including, but not limited to coating, application, or extrusion.

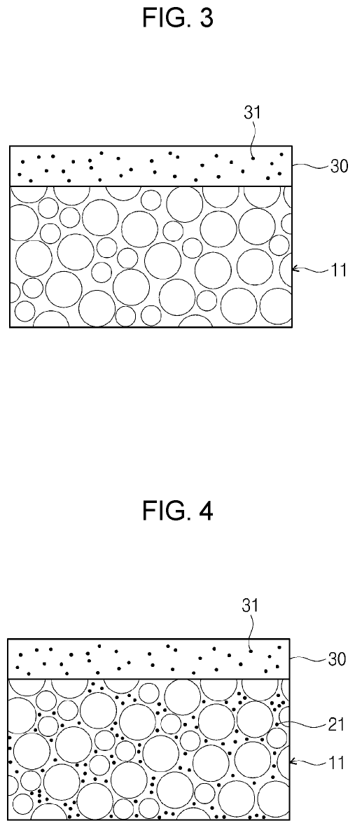

FIG. 3 is a diagram showing the cross-section of a biodegradable sheet with antiviral properties according to the second embodiment of the present invention; and FIG. 4 is a diagram showing the cross-section of a biodegradable sheet with antiviral properties according to the third embodiment of the present invention.

In the second and third embodiments of the present invention, a biodegradable extruded foam sheet 11 is formed with or without an inorganic antiviral agent 21, and a non-foam sheet 30 is formed on the extruded foam sheet 11. The non-foam sheet 30 contains 0.1 to 60 parts by weight of an inorganic antiviral agent 31 with respect to 100 parts by weight of a biodegradable polymer resin consisting of a polylactic acid (PAL)-based polymer or a petrochemical resin, not only to provide antiviral properties, but to increase the strength of the whole sheet.

Preferably, the non-foam sheet has a thickness of 50 to 500 μm, which may have dependence on the use purpose of the sheet. The thickness and strength specifications are subject to change according to the demand of the customer of the biodegradable sheet.

The present invention also provides a method for manufacturing a biodegradable sheet with antiviral properties.

The biodegradable sheet of the present invention includes a single-layered, multi-layered, non-foam, or foam structure formed by T-die, blown and extrusion foaming using a raw material resin that includes a biodegradable polymer resin consisting of a polylactic acid-based polymer; or a multi-degradable polymer resin consisting of a biodegradable resin and a petrochemical resin. The structure with a thickness of 0.254 mm or greater is defined as a sheet, whereas the structure with a thickness less than 0.254 mm is defined as a film.

More specifically, there is provided a method for manufacturing the biodegradable sheet with antiviral properties according to the first embodiment of the present invention, which biodegradable sheet uses a raw material resin selected from a biodegradable polymer resin consisting of a polylactic acid-based polymer or a multi-degradable polymer resin consisting of a biodegradable resin and a petrochemical resin, or any one or at least one plant material selected from the group consisting of pulp, bagasse, and flax fiber. The manufacturing method includes mixing 0.1 to 60 parts by weight of an inorganic antiviral agent with respect to 100 parts by weight of the raw material resin or the at least one plant material so that particles of an inorganic antiviral agent or aggregated composite particles of at least two inorganic antiviral agents can be dispersed with a particle size of 100 to 900 nm in the biodegradable sheet.

Further, the biodegradable sheet of the present invention may use any one or at least one plant material selected from the group consisting of pulp, bagasse, and flax fiber. This method has the same process of the first embodiment in that the inorganic antiviral agent is mixed into the plant material.

In addition, there is provided a method for manufacturing the biodegradable sheet with antiviral properties according to the second embodiment of the present invention that includes mixing 0.05 to 4 parts by weight of a chain extender, 0.01 to 4 parts by weight of any one nucleating agent selected from the group consisting of talc, silica, and calcium stearate, and 1 to 30 parts by weight of a physical foaming agent with respect to 100 parts by weight of a biodegradable polymer resin consisting of a polylactic acid-based polymer to prepare an extruded foam sheet through extrusion foaming; and laminating a non-foam sheet containing an inorganic antiviral agent mixed into a bio-degradable polymer resin consisting of a polylactic acid-based polymer or a petrochemical resin on at least one side of the extruded foam sheet.

In addition, there is provided a method for manufacturing the biodegradable sheet with antiviral properties according to the third embodiment of the present invention that includes mixing 0.1 to 60 parts by weight of an inorganic antiviral agent in the step of preparing an extruded foam sheet according to the second embodiment so that particles of an inorganic antiviral agent or aggregated composite particles of at least two inorganic antiviral agents can be dispersed with a particle size of 100 to 900 nm in the biodegradable sheet; and laminating a non-foam sheet containing an inorganic antiviral agent mixed into a bio-degradable polymer resin consisting of a polylactic acid-based polymer or a petrochemical resin on at least one side of the extruded foam sheet.

In the manufacturing methods for the biodegradable sheets with antiviral properties according to the second and third embodiments, the non-foam sheet containing an inorganic antiviral agent mixed into a polylactic acid-based polymer is laminated on at least one side of the extruded foam sheet, to impart strength to the biodegradable sheet. The thickness and strength specifications of the biodegradable sheet are subject to change according to the use purpose of the biodegradable sheet.

Preferably, the non-foam sheet has a thickness of 50 to 500 μm. When the non-foam sheet is thinner than 50 μm, the extrusion lamination process may result in forming the biodegradable sheet with a non-uniform thickness. When the non-foam sheet is thicker than 500 μm, the cell structure of the foam layer becomes unstable.

In the biodegradable sheets with antiviral properties according to the second and third embodiments, the extruded foam sheet is prepared by mixing 0.05 to 4 parts by weight of a chain extender, 0.01 to 4 parts by weight of any one nucleating agent selected from the group consisting of talc, silica, and calcium stearate, and 1 to 30 parts by weight of a physical foaming agent with respect to 100 parts by weight of a biodegradable polymer resin consisting of a polylactic acid-based polymer, and conducting an extrusion foaming process.

In the preparation of the extruded foam sheet, the polylactic acid as used in the present invention, with a low molecular weight, is likely to break due to its strength not high enough even if dried well, so it is difficult to proceed with a post-processing. Therefore, a chain extender is used for the purpose of increasing the molecular weight of the polylactic acid.

A preferred example of the chain extender as used in the present invention is any one or at least one selected from the group consisting of an epoxy-based compound, an isocyanate-based compound, a (meth)acrylic compound, and a peroxide-based compound. The epoxy-based compound is selected from the group consisting of diglycidyl ether, terephthalic acid diglycidyl ether, trimethylolpropane diglycidyl ether, and 1,6-hexanediol diglycidyl ether. The isocyanate-based compound is selected from the group consisting of hexamethylene diisocyanate, tolylene diisocyanate, xylylene diisocyanate, and diphenylmethane di- and triisocyanates. The peroxide-based compound is selected from the group consisting of lauroyl peroxide, benzoyl peroxide, azo-bis-isobutylonitrile, tribtyl hydroperoxide, dicumyl peroxide, di-tributyl peroxide, 2,5-dimethyl-2,5-di(t-butyl peroxy)hexane, and 1,3-bis(t-butyl peroxy-isopropyl)benzene.

When the chain extender is used in an amount of 0.05 to 4 parts by weight, more preferably 0.1 to 2 parts by weight, with respect to 100 parts by weight of the polylactic acid, it has a significant effect of improving thermal resistance. The content of the chain extender less than 0.05 part by weight results in an insignificant effect of increasing the molecular weight of the polylactic acid, making it difficult to obtain the final product in the sheet form. The content of the chain extender exceeding 4 parts by weight helps increase crystallinity and thermal resistance, but renders the extruder die at risk of clogging due to an excessive increase in the molecular weight and cross-links, thereby causing process issues. Examples of the nucleating agent used in the preparation of the extruded foam sheet may be inorganic nucleating agents, such as talc and silica, or organic nucleating agents, such as calcium stearate. Particularly, the nucleating agent may be added in the form of a master batch. In the preparation of the master batch, a dispersant, a stabilizer, an antioxidant, a UV stabilizer, a lubricant, or the like may be further added not only to adjust the dispersibility of the nucleating agent, but to increase processability. Also, the dispersant may be further added separately rather than mixed into the master batch. The dispersant as used in this case may be amide stearate or the like.

The nucleating agent is preferably contained in an amount of 0.01 to 4 parts by weight with respect to 100 parts by weight of the polylactic acid-based polymer composition. When the content of the nucleating agent is far too low, less than 0.01 part by weight, it cannot cause the particles of the polylactic acid-based resin to produce foam. When the content of the nucleating agent exceeds 4 parts by weight, the nucleating agent no longer functions, and there is a risk that the foam particles may have a lack of expandability or fusion ability in a mold during a molding process.

In addition, a foaming agent, along with the particles of the polylactic acid-based polymer and the nucleating agent, is loaded with pressure on a first extruder. The content of the foaming agent is 1 to 30 parts by weight, preferably 3 to 20 parts by weight. Examples of the foaming agent as used herein may include any one selected from the group consisting of propane, isobutane, n-butane, and cyclobutane, which may be used alone or in a combination of two or more thereof; any one selected from the group consisting of isopentane, n-pentane, or cyclopentane, which may be used alone or in a combination of two or more thereof; any one selected from the group consisting of isohexane, n-hexane, cyclohexane, trichlorofluoromethane, dichlorodifluoromethane, chlorofluoromethane, trifluoromethane, 1,1,1,2-tetrafluoroethane, 1-chloro-1,1-difluoroethane, 1,1-difluoroethane, and 1-chloro-1,2,2,2-tetrafluoroethane, which may be used alone or in a combination of two or more thereof; or a physical foaming agent, such as nitrogen, carbon dioxide, argon, or air. Among these foaming agents, physical foaming agents are preferable because they are inexpensive and not likely to destroy the ozone layer. Specifically, nitrogen, air, or carbon dioxide is preferred. In terms of the content of the foaming agent, carbon dioxide is preferred in that it allows particle foams to be produced with relatively low apparent density. Further, a combination of two or more foaming agents can be used; for example, carbon dioxide and isobutane.

The inorganic antiviral agents 21 and 31 used in the first, second and third embodiments of the present invention are as described in the disclosure of the biodegradable sheet with antiviral properties.

In accordance with the first, second and third embodiments of the present invention, particles of an inorganic antiviral agent or aggregated composite particles of at least two inorganic antiviral agents are incorporated into the biodegradable sheet in such a manner that they are dispersed with a particle size of 100 to 900 nm. This enables the biodegradable sheet not only to prevent skin penetration of particles by the particle size control of the inorganic antiviral agent, but also to have the inorganic antiviral agent exercise an antiviral performance upon in contact with viruses by inactivation of the viruses prior to virus infection into the human body or inhibition of RNA replication even in the case of virus infection, thereby providing a biodegradable sheet with antiviral properties.

Even when viruses, particularly RNA viruses have infected the human body, the nanoparticles of the inorganic antiviral agent are adsorbed on the RNA to interfere with RNA replication, thereby exercising an antiviral performance.

The biodegradable sheet with antiviral properties according to the present invention exerts the antiviral performance against any one selected from the group consisting of feline coronavirus (fCoV), influenza A virus (FluA), avian influenza (AI) virus, and swine virus.

Furthermore, the biodegradable sheet with antiviral properties according to the first embodiment of the present invention can exercise an antiviral performance with the inorganic antiviral agent, which is incorporated into the biodegradable sheet. Hence, the thickness of the biodegradable sheet means that of the final product.

The present invention can provide the biodegradable sheet with antiviral properties according to the first embodiment of the present invention as a thin sheet product. This can meet the demand of the market for personal items or disposable products against different viruses causing severe acute respiratory syndrome (SARS), avian flu, mass food poisoning, coronavirus (COVID-19) infection, etc.

Also, the present invention can be used in the parts available to personal protective equipment (PPE).

For example, it is applicable to food trays or general food containers, disposable or portable, such as lunch box containers or other types of food containers; furthermore, parts of air purifiers, medicinal containers, industrial containers, special packaging boxes, and so forth.

The biodegradable sheets with antiviral properties according to the second and third embodiments of the present invention can be provided as molded products that not only exercise an antiviral performance but also display strength improved by lamination of a non-foam sheet.

Specifically, they are available to food containers or packaging materials for food containers, including food trays, cups, instant noodle cups, containers, lunch box containers, and other packaging materials for food containers.

Hereinafter, the present invention will be described in further detail with reference to examples and test examples, which are given for the understanding of the present invention and not intended to limit the scope of the present invention.

### Example 1

1 part by weight of ZnO nanoparticles were mixed with respect to 100 parts by weight of PLA resin (Luminy® L175, Total Corbion PLA). The mixture was well mixed with a general mixer such as a tumbling mixer. Then, a twin-screw extruder having an inner diameter of 65 mm was used to form pellets with uniform composition. The temperature profile from hopper inlet to extrusion die was set as 260/220/230/230/180/150° C. to extrude a sheet. The pellets were fed as a raw material into a first extruder having an inner diameter of 90 mm. An extruded non-foam sheet was produced using a tandem extruder equipped with a first extruder (inner diameter 90 mm) and a second extruder (inner diameter 120 mm) that were connected to each other.

The particles of the polylactic acid resin were fed into the first extruder and subjected to heat and melting and mixing. They were forced into the first extruder under pressure. The residence time was 10 minutes, and the heat-and-melting temperature was maintained at 170 to 230° C. Then, in the second extruder connected to the first extruder, the temperature of the molten reactant mixture was slightly reduced until the temperature of the resin reached 150° C.

Finally, a 300 μm thick ZnO-incorporated PLA biodegradable sheet (referred to as “nZnO”) was discharged in the direction of extrusion from a circular die with cylindrical slits having a diameter of 110 mm and a slit separation of 0.5 mm.

### Example 2

The procedures were performed in the same manner as described in Example 1, excepting that 1 part by weight of ZnO nanoparticles and 1 part by weight of CuI were mixed with respect to 100 parts by weight of PLA resin (Luminy® L175, Total Corbion PLA) to prepare a ZnO/CuI-incorporated PLA biodegradable sheet (referred to as “CuZn”).

### Example 3

The procedures were performed in the same manner as described in Example 1, excepting that 1 part by weight of a silver ion-containing nanocomposite using silica particles bound to silver and zinc ions was mixed with respect to 100 parts by weight of PLA resin (Luminy® L175, Total Corbion PLA) to prepare a silver ion-containing nanocomposite-incorporated PLA biodegradable sheet (referred to as “AgNP”).

### Example 4

The procedures were performed in the same manner as described in Example 1, excepting that 1 part by weight of CuI was mixed with respect to 100 parts by weight of PLA resin (Luminy® L175, Total Corbion PLA) to prepare a CuI-incorporated PLA biodegradable sheet (referred to as “CuI”).

### Example 5

The procedures were performed in the same manner as described in Example 1, excepting that 1 part by weight of ZnO nanoparticles, 1 part by weight of silica particles (AgNP) bound to silver and zinc ions, and 1 part by weight of CuI were mixed with respect to 100 parts by weight of PLA resin (Luminy® L175, Total Corbion PLA) to prepare a ZnO/silver ion-containing nanocomposites/CuI-incorporated PLA biodegradable sheet (referred to as “nZnAgCu”).

### Example 6

1.0 part by weight of an epoxy-based chain extender, 1.8 part by weight of talc having a size of 0.1 to 5 μm as a nucleating agent, 1.0 part by weight of acetyl tributyl citrate as a plasticizer, and 1 part by weight of ZnO nanoparticles were mixed with respect to 100 parts by weight of PLA resin (Revode 190, Hisun Biomaterials). The mixture was well mixed with a general mixer such as a tumbling mixer. Then, a twin-screw extruder having an inner diameter of 65 mm was used to form pellets with uniform composition. The pellets were fed as a raw material into a first extruder having an inner diameter of 90 mm. An extruded non-foam sheet was produced using a tandem extruder equipped with a first extruder (inner diameter 90 mm) and a second extruder (inner diameter 120 mm) that were connected to each other.

The particles of the polylactic acid resin were fed into the first extruder and subjected to heat and melting and mixing. 2.5 parts by weight of butane used as a foaming agent was forced into the first extruder under pressure. The residence time was 10 minutes. Then, a separate T-die extruder was used to extrude the ZnO-incorporated PLA resin on the one side of a foam sheet, thus completing a 300 μm thick lamination coating layer.

### Example 7

The procedures were performed in the same manner as described in Example 4, excepting that a PLA-based non-foam sheet prepared from a raw material resin composed of 25 wt. % PLA, 55 wt. % PBAT and 20 wt. % CaCO₃ (filler) was used in place of PLA.

### Example 8

The procedures were performed in the same manner as described in Example 4, excepting that a PLA-based non-foam sheet prepared from a raw material resin composed of 15 wt. % PBS, 55 wt. % PBAT and 30 wt. % TPS (modified starch) was used in place of PLA.

### Example 9

The procedures were performed in the same manner as described in Example 1, excepting that 1 part by weight of ZnO nanoparticles and 0.01 part by weight of ferrite nanoparticles were mixed with respect to 100 parts by weight of PLA resin (Luminy® L175, Total Corbion PLA). The ferrite nanoparticles were a combination of alpha-ferrite (α-Fe₂O₃), zinc ferrite (ZnFe₂O₄) and manganese ferrite (MnFe₂O₄). The final product was a ZnO/ferrite-incorporated PLA biodegradable sheet (referred to as “ZnOFe”).

### Comparative Example 1

The procedures were performed in the same manner as described in Example 1, excepting that the inorganic antiviral agent was not mixed into the PLA resin (Luminy® L175, Total Corbion PLA).

### Experimental Example 1

Morphological Evaluation of Sheet

Using an electron microscope (Bruker Corp.), microscopic images were taken to examine the cross-sections of 300 μm thick PLA biodegradable sheets containing inorganic antiviral agents as prepared in Examples 1 to 5.

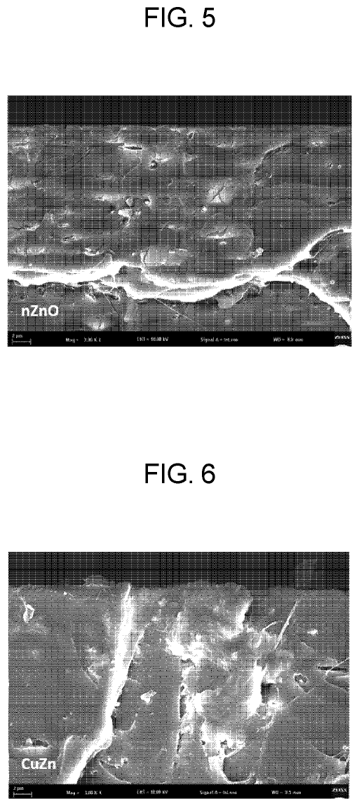

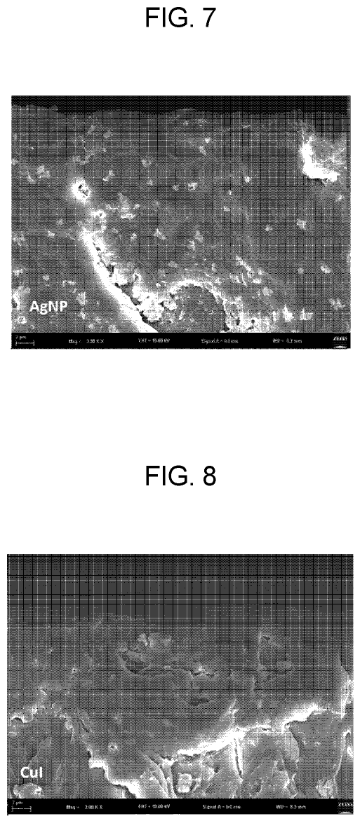

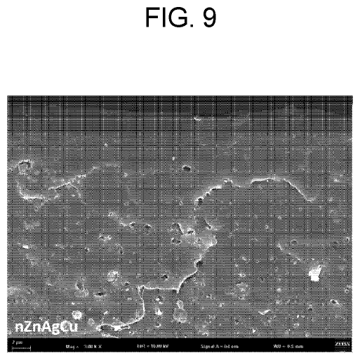

FIGS. 5 to 9 present the cross-sectional microscopic images of the PLA biodegradable sheets prepared in the respective embodiments. It was confirmed that the inorganic antiviral agents were entirely well dispersed; 50% or more of the particles of a single inorganic antiviral agent or the aggregated composite particles of at least two inorganic antiviral agents were dispersed with a particle size of 100 to 300 nm.

Particularly, in the silver ion-containing nanocomposites-incorporated PLA biodegradable sheet of Example 3, 50% or more of the particles of a single inorganic antiviral agent or the aggregated composite particles of at least two inorganic antiviral agents were 150 to 200 nm in particle size.

### Experimental Example 2

Antiviral Performance Evaluation

The PLA biodegradable sheets containing inorganic antiviral agents prepared in Examples 1 to 9 were evaluated in regards to the antiviral performance against Influenza virus (FluA) or feline coronavirus (fCoV) [test and evaluation carried out by the government-funded research institute].

Specifically, 5 μl of the relevant virus solution was applied on the surface of each sheet (1 cm×1 cm) twice. For collection of the virus, 350 μl of MEM was added, and the reaction time was set to 30 minutes to cause the reaction at room temperature (23° C.).

For evaluation standards, virus reduction was observed in 10 minutes and 2 hours after inoculation of the relevant virus. The following Table 1 presents the virus reduction in terms of log reduction achieved by the antiviral effect in 2 hours after inoculation. The higher log reduction means the larger number of viruses eliminated by disinfection.

TABLE 1

| | Inorganic | Dispersed | | |
|---|---|---|---|---|
| | antiviral | average particle | | |
| Div. | agents | size (nm) | FluA | FCoV |
| Example 1 | nZnO | 100~300 | 1 | 0.5~l |
| Example 2 | CuZn | 100~300 | >2 | 0.5~2 |
| Example 3 | AgNP | 150~200 | >4 | 0.5~1 |
| Example 4 | CuI | 150~200 | >4 | 1.7~2 |
| Example 5 | nZnAgCu | 150~200 | >3 | 0.5~1.5 |
| Example 7 | CuI | 150~200 | >3 | 1.7~2 |
| Example 8 | CuI | 150~200 | >3 | 1.6~2 |
| Example 9 | ZnOFe | ~100 | 4.90 | 1.77 |
| Comparative | | | 0.7 | 0.4 |
| Example 1 | | | | |

As can be seen from the results of Table 1, particles of an inorganic antiviral agent or aggregated composite particles of at least two inorganic antiviral agents incorporated into the biodegradable sheets of the present invention were dispersed with a particle size of 100 to 900 nm. In addition, the PLA biodegradable sheets with inorganic antiviral agents using any one or a combination of at least two selected from the group consisting of a silver ion-containing nanocomposite, copper(I) compound nanoparticles, and zinc oxide nanoparticles according to Examples 1 to 9 showed much higher antiviral performance against Influenza virus (FluA) or feline coronavirus (fCoV) than that of Comparative Example 1.

The foregoing description of the invention has been presented for purposes of illustration and description, and obviously many modifications and variations are possible without departing from the principles and the substantial scope of the present invention. The scope of the claims of the present invention includes such modifications and variations belonging to the principles of the present invention.

What is claimed is:

1. A biodegradable sheet with antiviral properties, comprising:
a biodegradable polymer resin consisting of a polylactic acid-based polymer; or a composite degradable polymer resin comprising of a biodegradable resin and a petrochemical resin; and
particles of an inorganic antiviral agent or aggregated composite particles of at least two inorganic antiviral agents incorporated into the biodegradable sheet so that the inorganic antiviral agent can be dispersed with a particle size of 100 to 900 nm.

2. The biodegradable sheet with antiviral properties according to claim 1, wherein the inorganic antiviral agent is any one or a combination of at least two selected from the group consisting of a silver nanocomposite, a silver ion-containing nanocomposite, copper(I) compound nanoparticles, zinc oxide nanoparticles and ferrite nanoparticles.

3. The biodegradable sheet with antiviral properties according to claim 2, wherein the silver nanocomposite or the silver ion-containing nanocomposite includes silver nanoparticles or silver ion-containing nanoparticles adsorbed on or bound to any one selected from the group consisting of a mineral, talc, a cellulose derivative, paraffin and wax, wherein the mineral comprises silica (SiO₂), alumina, zeolite, sericite, mordenite, cristobalite, and bentonite.

4. The biodegradable sheet with antiviral properties according to claim 2, wherein the ferrite nanoparticles are at least one or more selected from the group consisting of alpha-ferrite (α-Fe₂O₃), zinc ferrite (ZnFe₂O₄), manganese ferrite (MnFe₂O₄), nickel ferrite (NiFe₂O₄) and ferric hydroxide (α-FeOOH).

5. The biodegradable sheet with antiviral properties according to claim 1, wherein the inorganic antiviral agent is contained in an amount of 0.1 to 60 parts by weight with respect to 100 parts by weight of the biodegradable polymer resin or the composite degradable polymer resin.

6. The biodegradable sheet with antiviral properties according to claim 1, wherein the biodegradable resin is any one or a combination of at least two selected from the group consisting of polylactic acid (PLA), polyhydroxyalkanoate (PHA), polybutylene adipate-co-terephthalate (PBAT), polybutylene succinate-co-adipate (PBSA), polybutylene succinate adipate-co-terephthalate (PBSAT), polybutylene succinate (PBS), polyvinyl alcohol (PVA), poly glycolic acid (PGA), poly lactic-co-glycolic acid (PLGA), polycaprolactone (PCL), modified starch resin and thermoplastic starch (TPS).

7. The biodegradable sheet with antiviral properties according to claim 1, wherein the biodegradable sheet is comprised of any one or at least one plant material selected from the group consisting of pulp, bagasse and flax fiber.

8. The biodegradable sheet with antiviral properties according to claim 1, wherein a non-foam sheet containing 0.1 to 60 parts by weight of the inorganic antiviral agent with respect to 100 parts by weight of the bio-degradable polymer resin consisting of a polylactic acid-based polymer or the petrochemical resin is laminated on at least one side of an extruded foam sheet prepared by extrusion foaming using a mixture containing 0.05 to 4 parts by weight of a chain extender, 0.01 to 4 parts by weight of any one nucleating agent selected from the group consisting of talc, silica, and calcium stearate, and 1 to 30 parts by weight of a physical foaming agent with respect to 100 parts by weight of the biodegradable polymer resin consisting of a polylactic acid-based polymer.

9. The biodegradable sheet with antiviral properties according to claim 8, wherein the inorganic antiviral agent is further incorporated into the extruded foam sheet, so particles of an inorganic antiviral agent or aggregated composite particles of at least two inorganic antiviral agents are dispersed with a particle size of 100 to 900 nm.

10. The biodegradable sheet with antiviral properties according to claim 8, wherein the non-foam sheet has a thickness of 50 to 500 μm.

11. A method for manufacturing a biodegradable sheet with antiviral properties, which method is for manufacturing a biodegradable sheet using a raw material resin selected from a biodegradable polymer resin consisting of a polylactic acid-based polymer or a composite degradable polymer resin consisting of a biodegradable resin and a petrochemical resin, or at least one plant material selected from the group consisting of pulp, bagasse and flax fiber,
wherein the method comprises mixing 0.1 to 60 parts by weight of an inorganic antiviral agent with respect to 100 parts by weight of the raw material resin or the plant material so that particles of an inorganic antiviral agent or aggregated composite particles of at least two inorganic antiviral agents can be dispersed with a particle size of 100 to 900 nm in the biodegradable sheet.

12. The method according to claim 11, wherein the inorganic antiviral agent is any one or a combination of at least two selected from the group consisting of a silver nanocomposite, a silver ion-containing nanocomposite, copper(I) compound nanoparticles, zinc oxide nanoparticles and ferrite nanoparticles.

13. The method according to claim 12, wherein the silver nanocomposite or the silver ion-containing nanocomposite includes silver nanoparticles or silver ion-containing nanoparticles adsorbed on or bound to any one selected from the group consisting of a mineral, talc, a cellulose derivative, paraffin and wax, wherein the mineral comprises silica (SiO₂), alumina, zeolite, sericite, mordenite, cristobalite and bentonite.

14. The method according to claim 12, wherein the ferrite nanoparticles are at least one or more selected from the group consisting of alpha-ferrite (α-Fe₂O₃), zinc ferrite (ZnFe₂O₄), manganese ferrite (MnFe₂O₄), nickel ferrite (NiFe₂O₄) and ferric hydroxide (α-FeOOH).

15. A method for manufacturing a biodegradable sheet with antiviral properties, the method comprising:
mixing 0.05 to 4 parts by weight of a chain extender, 0.01 to 4 parts by weight of any one nucleating agent selected from the group consisting of talc, silica and calcium stearate, and 1 to 30 parts by weight of a physical foaming agent with respect to 100 parts by weight of a biodegradable polymer resin consisting of a polylactic acid-based polymer to prepare an extruded foam sheet through extrusion foaming; and
laminating a non-foam sheet containing an inorganic antiviral agent mixed into a bio-degradable polymer resin consisting of a polylactic acid-based polymer or a petrochemical resin on at least one side of the extruded foam sheet.

16. The method according to claim 15, wherein the inorganic antiviral agent is any one or a combination of at least two selected from the group consisting of a silver nanocomposite, a silver ion-containing nanocomposite, copper(I) compound nanoparticles, zinc oxide nanoparticles and ferrite nanoparticles.

17. The method according to claim 15, wherein the inorganic antiviral agent is further incorporated into the extruded foam sheet in an amount of 0.1 to 60 parts by weight with respect to 100 parts by weight of the biodegradable polymer resin consisting of a polylactic acid-based polymer.

18. The method according to claim 15, wherein the non-foam sheet has a thickness of 50 to 500 μm.

19. The method according to claim 17, wherein the inorganic antiviral agent is any one or a combination of at least two selected from the group consisting of a silver nanocomposite, a silver ion-containing nanocomposite, copper(I) compound nanoparticles, zinc oxide nanoparticles and ferrite nanoparticles.

20. A molded product using the biodegradable sheet with antiviral properties according to claim 1 applied to any one selected from the group consisting of food trays, food containers, medicinal containers, industrial containers, personal protective equipment (PPE) parts, air purifier parts, industrial packaging boxes and packaging materials.
